(19) United States
(12) Patent Application Publication
(10) Pub. No.: US 2024/0185217 A1
(43) Pub. Date: Jun. 6, 2024

(54) DIGITAL FINANCIAL MANAGEMENT HAVING AUTOMATED ROUND-UP SAVINGS

(71) Applicant: Truist Bank, Charlotte, NC (US)

(72) Inventor: Kobe Ampomah, Henrico, VA (US)

(21) Appl. No.: 18/061,975

(22) Filed: Dec. 5, 2022

(51) Int. Cl. G06Q 20/32; G06Q 20/22

(52) U.S. Cl. CPC G06Q 20/326; G06Q 20/22; G06Q 20/3223

(57) ABSTRACT

A computing device, computer program product, and a computer-implemented method for delivering financial services and, more particularly, for facilitating enhanced network communication between a user and a financial institution. A user having one or more financial accounts at the financial institution is given a digital platform to automatically transfer a difference between a rounded-up monetary amount and an actual monetary amount involved in a financial payment transaction from one or more user-designated financial accounts to one or more user-designated beneficiary financial accounts.

### TECHNICAL FIELD

The present disclosure relates to a computing device, computer program product, and computer-implemented method for delivering digital financial services and, more particularly, for facilitating accumulation of customer savings while promoting financial literacy via an automated contribution program for automatically contributing a monetary amount from one or more user accounts to one or more user-designated beneficiary accounts during a purchase transaction.

### BACKGROUND

Financial institutions that provide financial services are increasingly providing a greater number of client services. Such financial institutions offer services that include a personal savings account that provides financial security for a client user having one or more financial accounts at the financial institution. Once an adequate emergency fund is established, the personal savings account can also provide seed money needed for higher-yielding investments such as stocks, bonds, and mutual funds.

There is an ever-increasing need for consumers to increase their savings goals. For the vast majority of consumers, research shows that periodic savings efforts, in the midst of current spending needs and habits, are insufficient to sustain any significant accumulation.

In a traditional cash-based monetary system, consumers had the ability to save spare change from purchases, and depositing the spare change in piggy banks. In the present digital age where credit cards, debit cards, and mobile wallets are prevalent, consumers have lost the ability to save spare change, leading to a diminishment in saving habits and financial literacy. Many such consumers understand the need to have an effective platform by which they may save money while also teaching financial literacy.

### SUMMARY

The present disclosure relates to a computing device, a computer program product, and a computer-implemented method for delivering enhanced digital financial services over a communication network while promoting financial literacy.

In accordance with one or more embodiments set forth, illustrated, and described herein, a computing device, a computer program product, and a computer-implemented method is provided for an automated contribution program which facilitates an automated monetary contribution between user accounts at a financial institution.

For example, a user, having one or more financial accounts at the financial institution, is given a digital platform to automatically transfer a difference between a rounded-up monetary amount and an actual monetary amount involved in a financial payment transaction from one or more user-designated financial accounts to one or more user-designated beneficiary financial accounts. For example, a user may be engaged in a purchase/payment transaction involving a monetary amount that is paid or otherwise remitted using monetary funds from a user-designated financial account. The purchase/payment transaction amount is automatically rounded-up to a nearest whole dollar (USD). The difference between the rounded-up monetary amount and the actual monetary amount involved in the financial payment transaction is the automatically transferred, in whole or in part, from the user-designated financial account into one or more user-designated beneficiary accounts at the financial institution. The user may designate the type of payment transaction type either when opening an account or at a later time so as to provide a basis for determining whether a forthcoming transaction is to be part of the round-up savings program. The user may authorize the automatic transfer of a predetermined monetary amount from a user-designated beneficiary account to an investment account, a brokerage account, trust account, et. upon a predetermined threshold amount being reached by the user-designated beneficiary account.

A user may also wish to promote financial literacy to their children through responsible spending. The one or more user-designated beneficiary accounts may comprise subaccounts at the financial institution to which one or more legal minors is designated beneficiary. Each one of the subaccounts may be a savings account associated with a primary financial account held by the parent. The savings account could comprise an account held in trust for the benefit of the one or more minors.

In accordance with one or more embodiments set forth, illustrated, and described herein, an apparatus comprises one or more of the following: one or more processors; and a non-transitory memory coupled to the one or more processors, the non-transitory memory including a set of instructions of computer-executable program code, which when executed by the one or more processors, cause the apparatus to: dynamically detect a financial payment transaction having an actual monetary amount that is paid by a user using funds from a user-designated financial account at a financial institution; calculate, to a nearest whole number of the monetary amount based on the actual monetary amount, a rounded-up monetary amount; and cause, based on the detection, an automatic monetary transfer representing a difference between the rounded-up monetary amount and the actual monetary amount from the user-designated financial account to one or more user-designated beneficiary accounts at the financial institution.

In accordance with the apparatus, the set of instructions, which when executed by the one or more processors, cause the apparatus to receive from a client device of the user, an election by the user to participate in a round-up savings program offered by the financial institution.

In accordance with the apparatus, the set of instructions, which when executed by the one or more processors, cause the apparatus to store, by the one or more financial institution servers, the election in the non-transitory memory.

In accordance with the apparatus, the set of instructions, which when executed by the one or more processors, cause the apparatus to receive, from the client device, a selection by the user of one or more user-designated financial accounts to participate in the round-up savings program.

In accordance with the apparatus, the set of instructions, which when executed by the one or more processors, cause the apparatus to store the selection of the one or more user-designated financial accounts in the non-transitory memory.

In accordance with the apparatus, the set of instructions, which when executed by the one or more processors, cause the apparatus to receive, from the client device, a selection by the user of the one or more user-designated beneficiary accounts to receive the monetary transfer, each user-designated beneficiary account comprising a subaccount of the financial account.

In accordance with the apparatus, the set of instructions, which when executed by the one or more processors, cause the apparatus to store the selection of the one or more user-designated beneficiary accounts in the non-transitory memory.

In accordance with the apparatus, the set of instructions, which when executed by the one or more processors, cause the apparatus to cause display of, on a user interface of the client device via a software application associated with the financial institution, a graphical user interface (GUI) comprising a round-up savings program dashboard having a visual alert.

In accordance with the apparatus, the visual alert comprises a user-engageable graphical image prompting the user to selectively preview an account balance in the one or more user-designated beneficiary accounts.

In accordance with the apparatus, the set of instructions, which when executed by the one or more processors, cause the apparatus to cause, in response to the user engaging the user-engageable icon, the display of the account balance in the one or more user-designated beneficiary accounts.

In accordance with one or more embodiments set forth, illustrated, and described herein, a computer program product comprises at least one non-transitory computer readable medium having with a set of instructions of computer-executable program code, which when executed by one or more processors of a computing device, cause the computing device to conduct one or more of the following: dynamically detect a financial payment transaction having an actual monetary amount that is paid by a user using funds from a user-designated financial account at a financial institution; calculate, to a nearest whole number of the monetary amount based on the actual monetary amount, a rounded-up monetary amount; and cause, based on the detection, an automatic monetary transfer representing a difference between the rounded-up monetary amount and the actual monetary amount from the financial account to one or more user-designated beneficiary accounts at the financial institution.

In accordance with the computer program product, the set of instructions, which when executed by the one or more processors, cause the computing device to receive from a client device of the user, an election by the user to participate in a round-up savings program offered by the financial institution.

In accordance with the computer program product, the set of instructions, which when executed by the one or more processors, cause the computing device to store the election in the non-transitory memory.

In accordance with the computer program product, the set of instructions, which when executed by the one or more processors, cause the computing device to receive, from the client device, a selection by the user of one or more user-designated financial accounts to participate in the round-up savings program.

In accordance with the computer program product, the set of instructions, which when executed by the one or more processors, cause the computing device to store the selection of the one or more user-designated financial accounts in the non-transitory memory.

In accordance with the computer program product, the set of instructions, which when executed by the one or more processors, cause the computing device to receive, from the client device, a selection by the user of the one or more user-designated beneficiary accounts to receive the monetary transfer, each user-designated beneficiary account comprising a subaccount of the financial account.

In accordance with the computer program product, the set of instructions, which when executed by the one or more processors, cause the computing device to store the selection of the one or more user-designated beneficiary accounts in the non-transitory memory.

In accordance with the computer program product, the set of instructions, which when executed by the one or more processors, cause the computing device to cause display of, on a user interface of the client device via a software application associated with the financial institution, a GUI comprising a round-up savings program dashboard having a visual alert.

In accordance with the computer program product, the visual alert comprises a user-engageable graphical image prompting the user to selectively preview an account balance in the one or more user-designated beneficiary accounts.

In accordance with the computer program product, the set of instructions, which when executed by the one or more processors, cause the computing device to cause, in response to the user engaging the user-engageable graphical image, the display of the account balance in the one or more user-designated beneficiary accounts.

In accordance with one or more embodiments set forth, illustrated, and described herein, a computer-implemented method comprises one or more of the following: dynamically detecting, by one or more financial institution servers associated with a financial institution, a financial payment transaction having an actual monetary amount that is paid by a user using funds from a user-designated financial account at the financial institution; calculating, by the one or more financial institution servers to a nearest whole number of the monetary amount based on the actual monetary amount, a rounded-up monetary amount; and causing, by the one or more financial institution servers based on the detection, an automatic monetary transfer representing a difference between the rounded-up monetary amount and the actual monetary amount from the financial account to one or more user-designated beneficiary accounts at the financial institution.

In accordance with the computer-implemented method, further comprising receiving, by the one or more financial institution servers from a client device of the user, an election by the user to participate in a round-up savings program offered by the financial institution.

In accordance with the computer-implemented method, further comprising storing, by the one or more financial institution servers, the election in non-transitory memory of the one or more financial institution servers.

In accordance with the computer-implemented method, further comprising receiving, by the one or more financial institution servers from the client device, a selection by the user of one or more user-designated financial accounts to participate in the round-up savings program.

In accordance with the computer-implemented method, further comprising storing, by the one or more financial institution servers, the selection of the one or more user-designated financial accounts in the non-transitory memory.

In accordance with the computer-implemented method, further comprising receiving, by the one or more financial institution servers from the client device, a selection by the user of the one or more user-designated beneficiary accounts to receive the monetary transfer.

In accordance with the computer-implemented method, each user-designated beneficiary account comprises a subaccount of the financial account.

In accordance with the computer-implemented method, further comprising storing, by the one or more financial institution servers, the selection of the one or more user-designated beneficiary accounts in the non-transitory memory.

In accordance with the computer-implemented method, further comprising causing, by the one or more financial institution servers via a software application associated with the financial institution, display of a GUI comprising a round-up savings program dashboard on a user interface of the client device.

In accordance with the computer-implemented method, the round-up savings program dashboard includes a visual alert on the round-up savings program dashboard.

In accordance with the computer-implemented method, the visual alert comprises a user-engageable graphical image prompting the user to selectively preview an account balance in the one or more user-designated beneficiary accounts.

In accordance with the computer-implemented method, further comprising causing, by the one or more financial institution servers in response to the user engaging the user-engageable graphical image, the display of the account balance in the one or more user-designated beneficiary accounts.

### DRAWINGS

The various advantages of the exemplary embodiments will become apparent to one skilled in the art by reading the following specification and appended claims, and by referencing the following drawings, in which:

FIG. 1 illustrates a communication environment, in accordance with one or more embodiments set forth and described herein.

FIG. 2 illustrates a block diagram of the mobile device of FIG. 1.

FIG. 3 illustrates a block diagram of the personal computing device of FIG. 1.

FIG. 4 illustrates a block diagram of the one or more financial institution servers of FIG. 1.

FIGS. 5 and 6 respectively illustrate a round-up savings program dashboard for visual display on a user interface, in accordance with one or more embodiments set forth and described herein.

FIG. 7 illustrate a financial accounts dashboard for visual display on a user interface, in accordance with one or more embodiments set forth and described herein.

FIG. 8 illustrates a round-up savings program dashboard for visual display on a user interface, in accordance with one or more embodiments set forth and described herein.

FIG. 9 illustrate a beneficiary accounts dashboard for visual display on a user interface, in accordance with one or more embodiments set forth and described herein.

FIG. 10 illustrates a round-up savings program dashboard for visual display on a user interface, in accordance with one or more embodiments set forth and described herein.

FIG. 11 illustrates a balance preview dashboard for visual display on a user interface, in accordance with one or more embodiments set forth and described herein.

FIGS. 12 through 15 respectively illustrate a computer-implemented method, in accordance with one or more embodiments set forth and described herein.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “machine learning” relates to an application of AI that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-Implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code running on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, or system senses as sufficiently immediate for a particular process or determination to be made, or that enables the processor to keep up with some external process.

As used herein, “user” relates to a consumer, machine entity, and/or requesting party, and may be human or machine.

Upon the launching of a GUI comprising a dashboard of financial institution on a client device, a user may receive data and information on one or more branch employees based on the geographic location of the user, or a user request or query for one or more financial services that are offered by the financial institution.

In accordance with one or more embodiments set forth, illustrated, and described herein, a communication environment that facilitates enhanced user communication with a financial institution in support of user access and management of user accounts at the financial institution via a client device. A user, having one or more financial accounts at the financial institution, is given a digital platform to automatically transfer a difference between a rounded-up monetary amount and an actual monetary amount involved in a financial payment transaction from one or more user-designated financial accounts to one or more user-designated beneficiary financial accounts. For example, a user may be engaged in a purchase/payment transaction involving a monetary amount that is paid or otherwise remitted using monetary funds from a user-designated financial account. The purchase/payment transaction amount is automatically rounded-up to a nearest whole dollar (USD). The difference between the rounded-up monetary amount and the actual monetary amount is automatically transferred, in whole or in part, from the user-designated financial account into one or more user-designated beneficiary accounts at the financial institution. For example, the transferred monetary amount may be transferred in whole, by user designation, into a single user-designated beneficiary account among the one or more user-designated beneficiary accounts. Alternatively, the transferred monetary amount may be transferred in part into several user-designated beneficiary accounts. The user may designate the type of financial payment transaction type either when opening an account or at a later time so as to provide a basis for determining whether a forthcoming transaction is to be part of the round-up savings program.

Alternatively or additionally, a user may wish to promote financial literacy to their children through responsible spending. A subaccount at the financial institution may be created to which one or more legal minors is designated beneficiary. The subaccount may be a savings account associated with a primary financial account held by the parent. The savings account could comprise an account held in trust for the benefit of the one or more minors.

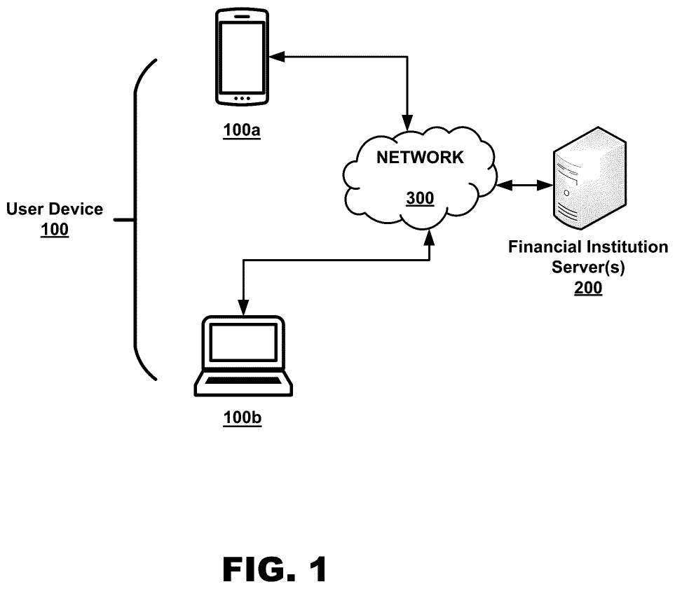

Turning to the figures, in which FIG. 1 illustrates a communication environment that facilitates communications between a user and a financial institution. A client device 100 operating in the communication environment facilitates user access to and user management of one or more user accounts residing at one or more financial institution servers 200 of the financial institution. The communication environment includes the client device 100, the one or more financial institution servers 200, and a communication network 300 through which communication is facilitated between the client device 100 and the one or more financial institution servers 200.

In accordance with one or more embodiments set forth, described, and/or illustrated herein, the client device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the client device 100 comprising any form of electronic device that optimizes or otherwise transforms the performance and functionality of the one or more embodiments in a manner that falls within the spirit and scope of the principles of this disclosure.

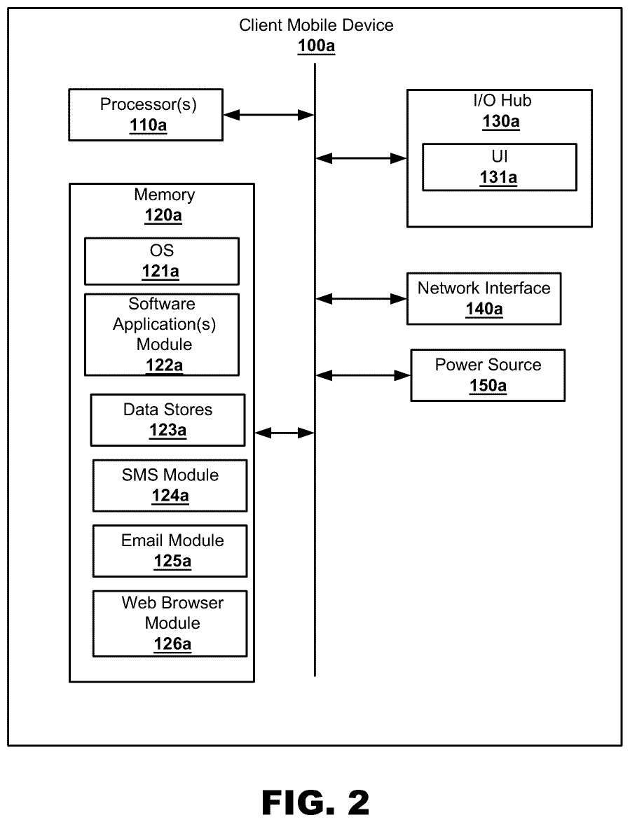

In the illustrated example embodiment of FIG. 2, the client device 100 comprises a mobile device 100A. Some of the possible operational elements of the mobile device 100A are illustrated in FIG. 2 and will now be described herein. It will be understood that it is not necessary for the mobile device 100A to have all the elements illustrated in FIG. 2. For example, the mobile device 100A may have any combination of the various elements illustrated in FIG. 2. Moreover, the mobile device 100A may have additional elements to those illustrated in FIG. 2.

The mobile device 100A includes one or more processors 110A, a non-transitory memory 120A operatively coupled to the one or more processors 110A, an I/O hub 130A, a network interface 140A, and a power source 150A.

The memory 120A comprises a set of instructions of computer-executable program code. The set of instructions are executable by the one or more processors 110A to cause execution of an operating system 121A and one or more software applications of a software application module 122A that reside in the memory 120A. The one or more software applications residing in the memory 120A includes, but is not limited to, a financial institution application that is associated with the financial institution. The financial institution application comprises a mobile application that facilitates establishment of a secure connection between the mobile device 100A and the one or more financial institution servers 200. The one or more processors 110A are operable to execute the mobile application to facilitate user access to the one or more user accounts and user management of the one or more user accounts.

The memory 120A also includes one or more data stores 123A that are operable to store one or more types of data. The mobile device 100A may include one or more interfaces that facilitate one or more systems or modules thereof to transform, manage, retrieve, modify, add, or delete, the data residing in the data stores 123A. The one or more data stores 123A may comprise volatile and/or non-volatile memory. Examples of suitable data stores 123A include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 123A may be a component of the one or more processors 110A, or alternatively, may be operatively connected to the one or more processors 110A for use thereby. As set forth, described, and/or illustrated herein, “operatively connected” may include direct or indirect connections, including connections without direct physical contact.

The memory 120A also includes an SMS module 124A operable to facilitate user transmission and receipt of text messages via the mobile device 100A though the network 300. In one example embodiment, a user may receive text messages from the financial institution that are associated with the user access and the user management of the one or more user accounts. An email module 125A is operable to facilitate user transmission and receipt of email messages via the mobile device 100A through the network 300. In one example embodiment, a user may receive email messages from the financial institution that are associated with the user access and the user management of the one or more user accounts. A user may utilize a web browser module 126A that is operable to facilitate user access to one or more websites associated with the financial institution through the network 300.

In accordance with one or more embodiments set forth, described, and/or illustrated herein, the mobile device 100A includes an I/O hub 130A operatively connected to other systems and subsystems of the mobile device 100A. The I/O system 130A may include one or more of an input interface, an output interface, and a network controller to facilitate communications between the client device 100 and the server 200. The input interface and the output interface may be integrated as a single, unitary user interface 131A, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110A to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100A may serve as both a component of the input interface and a component of the output interface.

The mobile device 100A includes a network interface 140A operable to facilitate connection to the network 300. The mobile device 100A also includes power source 150A that comprises a wired powered source, a wireless power source, a replaceable battery source, or a rechargeable battery source.

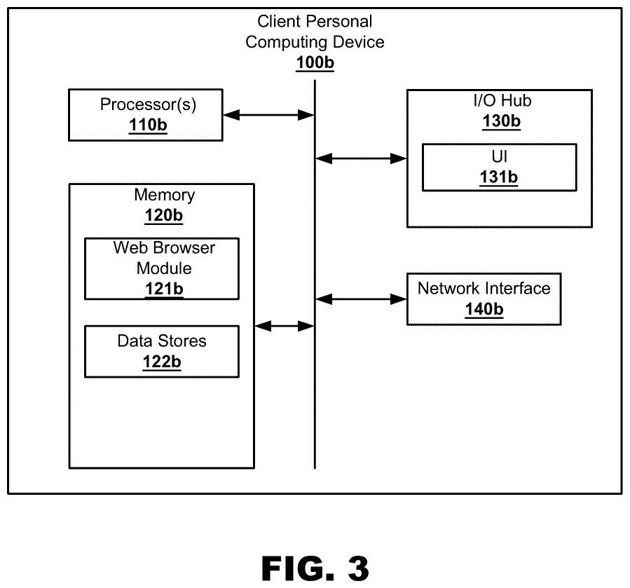

In the illustrated example embodiment of FIG. 3, the client device 100 comprises a personal computing device 100B. Some of the possible operational elements of the personal computing device 100B are illustrated in FIG. 3 and will now be described herein. It will be understood that it is not necessary for the personal computing device 100B to have all the elements illustrated in FIG. 3. For example, the personal computing device 100B may have any combination of the various elements illustrated in FIG. 3. Moreover, the personal computing device 100B may have additional elements to those illustrated in FIG. 3.

The personal computing device 100B includes one or more processors 110B, a non-transitory memory 120B operatively coupled to the one or more processors 110A, an I/O hub 130B, and a network interface 140B.

The memory 120B comprises a set of instructions of computer-executable program code. The set of instructions are executable by the one or more processors 110B to cause control of the web browser module 121B in a manner that facilitates user access to a web browser having one or more websites associated with the financial institution through the network 300.

The memory 120B also includes one or more data stores 122B that are operable to store one or more types of data. The personal computing device 100B may include one or more interfaces that facilitate one or more systems or modules thereof to transform, manage, retrieve, modify, add, or delete, the data residing in the data stores 122B. The one or more data stores 122A may comprise volatile and/or non-volatile memory. Examples of suitable data stores 122B include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 122B may be a component of the one or more processors 110B, or alternatively, may be operatively connected to the one or more processors 110B for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 110A, 100B may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110A, 110B may comprise at least one hardware circuit (e.g., an integrated circuit) operable to carry out instructions contained in program code. In embodiments in which there is a plurality of processors, such processors may work independently from each other, or one or more processors may work in combination with each other.

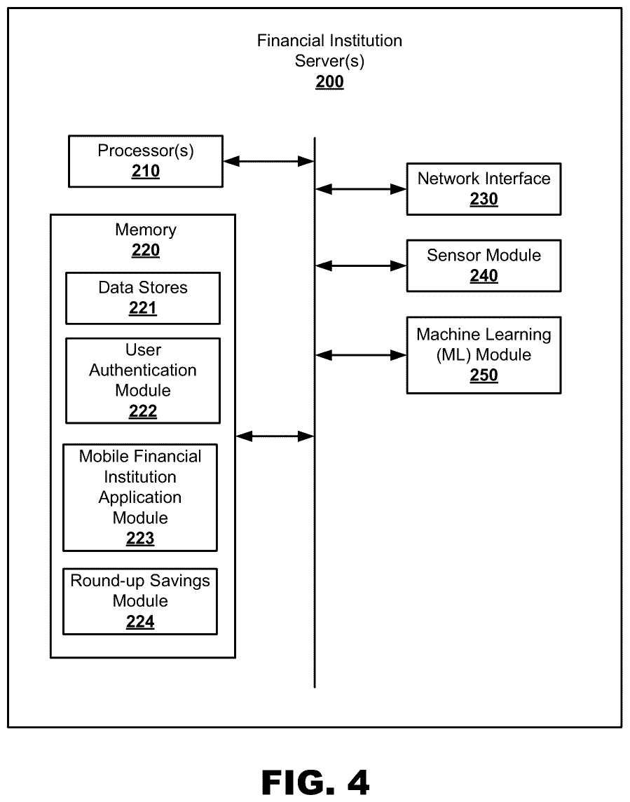

As illustrated in FIG. 4, the one or more financial institution servers 200 includes one or more processors 210, a non-transitory memory 220 operatively coupled to the one or more processors 210, a network interface 230, a sensor module 240, and a machine learning (ML) module 250. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 4. For example, each server in the one or more financial institution servers 200 may have any combination of the various elements illustrated in FIG. 4. Moreover, each server in the one or more financial institution servers 200 may have additional elements to those illustrated in FIG. 4.

The one or more financial institution servers 200 may be controlled by a system manager (or policy manager) of the financial institution.

In accordance with one or more embodiments set forth, described, and/or illustrated herein, the one or more financial institution servers 200 may comprise a computing device, including but not limited to a server computer, a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the one or more financial institution servers 200 comprising any form of electronic device that optimizes or otherwise transforms the performance and functionality of the one or more embodiments in a manner that falls within the spirit and scope of the principles of this disclosure.

The memory 220 comprises a set of instructions of computer-executable program code. The set of instructions are executable by the one or more processors 210 in manner that facilitates control of a user authentication module 222, a mobile financial institution application module 223, and a round-up savings module 224 having one or more mobile financial institution applications that reside in the memory 220. In accordance with one or more embodiments set forth, described, and/or illustrated herein, the one or more financial institution servers 200 may individually or collectively execute the instructions to perform any one or more of the methodologies set forth, described, and illustrated herein.

The memory 220 also includes one or more data stores 221 that are operable to store one or more types of data, including but not limited to, user account data, user authentication data, sensor data, etc. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The memory 220 may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by a server (e.g., server), such that the instructions, when executed by the one or more processors 210, cause the server(s) to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The computer-executable program code may instruct the one or more processors 210 to cause the user authentication module 221 to authenticate a user in order to gain user access to the one or more user accounts. The user authentication module 221 may be caused to request user input user data or user identification that include, but are not limited to, user identity (e.g., username), a user passcode, a cookie, user biometric data, a private key, a token, and/or another suitable authentication data or information.

The computer-executable program code may instruct the one or more processors 210 to execute certain logic, data-processing, and data-storing functions of the one or more financial institution servers 200, in addition to certain communication functions of the one or more financial institution servers 200. The one or more mobile financial institution applications of the mobile financial institution application module 222 are operable to communicate with the client device 100 in a manner which facilitates user access to the one or more user accounts in addition to user management of the one or more user accounts based on successful user authentication.

The sensor module 240 is operable, at least during execution of the mobile application by the client device 100, to dynamically detect, determine, assess, monitor, measure, quantify, and/or sense information about the client device 100. The sensor module 240 may be operable to detect, determine, assess, monitor, measure, quantify and/or sense in real-time. The sensor module 240 may be operable to detect, determine, assess, monitor, measure, quantify, and/or sense geographic location information about the geographic location of the client device 100.

The ML module 250 may include one or more ML algorithms to train one or more machine learning models of the one or more financial institution servers 200 based on data and/or information resided in the memory 220. The ML algorithms may include one or more of a linear regression algorithm, a logical regression algorithm, or a combination of different algorithms. A neural network may also be used to train the system based on the received data. The ML module 250 may analyze the received data and/or information, and transform the data and/or information in a manner which provides enhanced communication between the client device 100 and the one or more financial institution servers 200, while also enhancing user access and management of the one or more user accounts. The data and/or information may also be up-linked to other systems and modules in the one or more financial institution servers 200 for further processing to discover additional information that may be used to enhance the understanding of the information.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

In accordance with one or more embodiments set forth, described, and/or illustrated herein, a user may, via the client device 100, execute a mobile application associated with the financial institution over the communication network 300. Upon being authenticated by the user authentication module 221, the user may transmit via the client device 100, a service request or query to the one or more financial institution server(s) 200 for one or more financial services that are offered by the financial institution. Such financial services may include, but are not limited to, a round-up savings program offered by the financial institution.

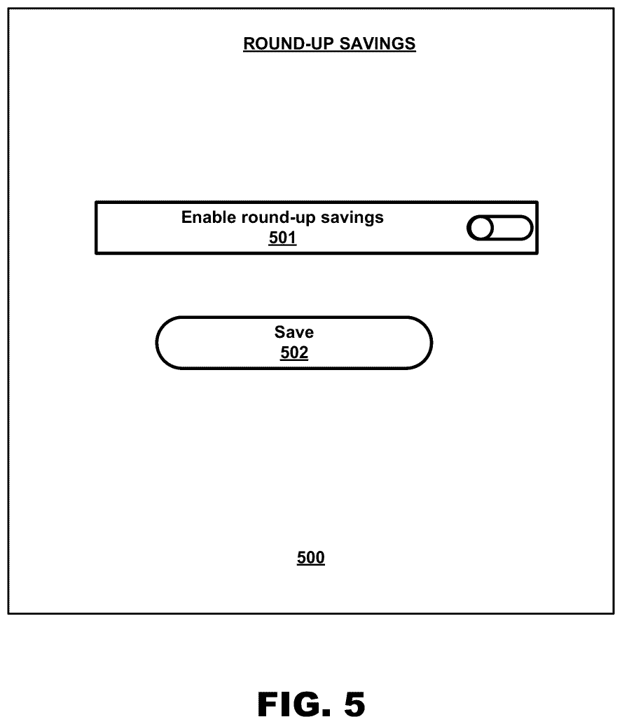

As illustrated in FIG. 5, the computer-executable program code may instruct the one or more processors 210 to cause (e.g., via the round-up savings module 224), over a communication network 300 via a software application associated with the financial institution (“financial institution software application”), the display, generation, or rendering of a GUI comprising a round-up savings dashboard 500 for visual display on a user interface 132 of the client device 100. The computer-executable program code may instruct the one or more processors 210 to cause the round-up savings module 224 to generate or otherwise render a widget on the round-up savings dashboard 500, the widget having a tile 501 with a user-engageable toggle switch to selectively enable or disable round-up savings by a user, and a user-engageable icon 502 to save the setting. This disclosure contemplates, temporally before displaying the round-up savings dashboard 500, the computer-executable program code instructing the one or more processors 210 to cause, over the communication network 300 via the financial institution software application, a presentation to the client device 100 an offer to participate in a round-up savings program that is associated with the financial institution.

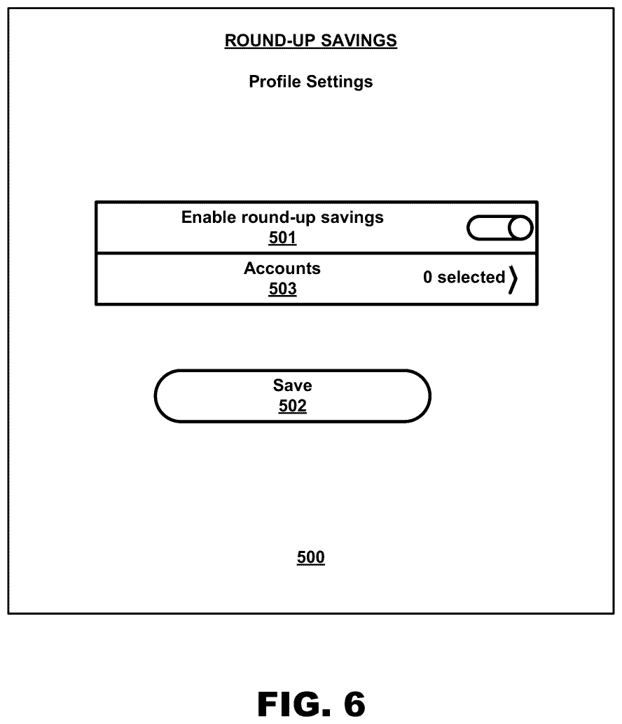

As illustrated in FIG. 6, responsive to the user selectively enabling round-up savings, the computer-executable program code may instruct the one or more processors 210 to cause, over the communication network 300 via the financial institution software application, the display, generation, or rendering of a tile 503 having a user engageable arrowhead that allows the user to select one or more user-designated financial accounts to participate in the round-up savings program. The user-designated financial accounts are the accounts used to engage in financial payment transactions, and from which the round-up monetary amount is to be deducted. The types of user-designated financial accounts to participate in the round-up savings program includes, but is not limited to, any user account associated with a personal account, a commercial account, and a wealth management account. Example accounts may include, but is not limited to, checking accounts, savings accounts, credit accounts, money market accounts (MMA), certificates of deposit (CD), lines-of-credit, etc.

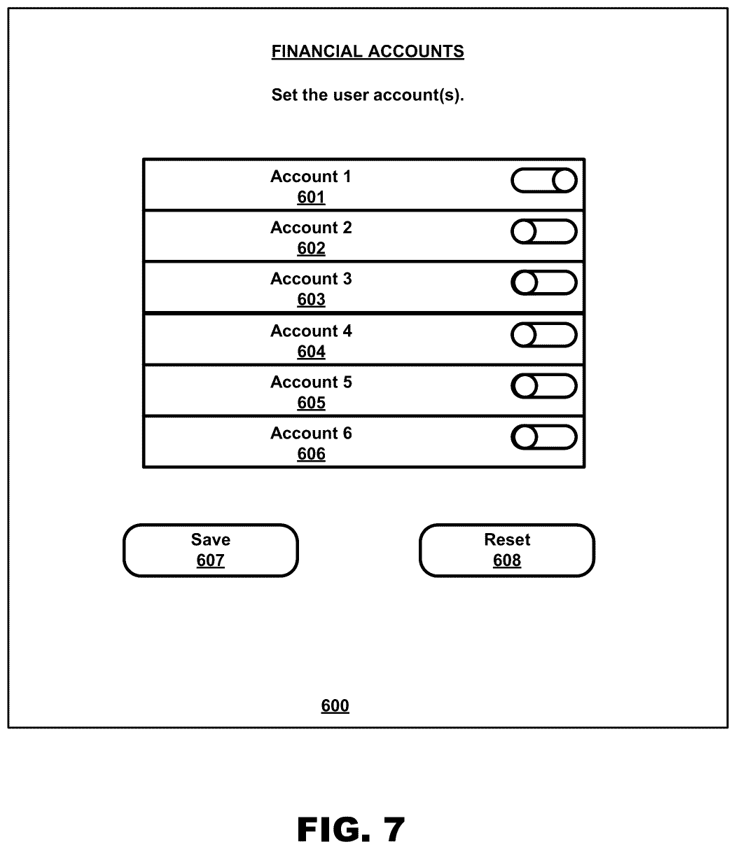

As illustrated in FIG. 7, responsive to the user selectively engaging the tile 503, the computer-executable program code may instruct the one or more processors 210 to cause, over the communication network 300 via the financial institution software application, the display, generation, or rendering of a GUI comprising a financial accounts dashboard 600 for visual display on the user interface 130A, 130B of the client device 100. The financial accounts dashboard 600 may comprise a widget having a plurality of tiles 601-606 that visually displays the overall financial accounts held by the user at the financial institution. Each tile 601-606 includes a user-engageable toggle switch to permit a user to selectively enable or disable one or more financial accounts that will participate in the round-up savings program. The financial accounts dashboard 600 also includes a user-engageable icon 607 to save the settings, and a user-engageable icon 608 to reset the settings. The computer-executable program code, in response to the user engaging the user-engageable icon 607 to save the setting, may then instruct the one or more processors 210 to store the selection in the non-transitory memory 220. A user may also designate the types of financial payment transactions (e.g., debit card payments, digital wallet payments, check payments, online bill payments, credit card payments, etc.) that will be subject to the round-up savings program.

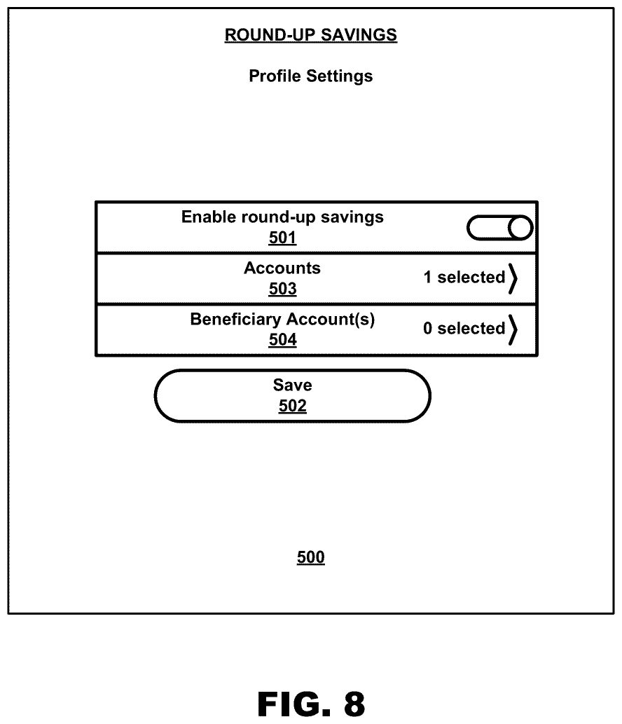

As illustrated in FIG. 8, responsive to storing the selection in the non-transitory memory 220, the computer-executable program code may instruct the one or more processors 210 to cause, over the communication network 300 via the financial institution software application, the display, generation, or rendering of a tile 504 having a user engageable arrowhead that allows the user to select one or more user-designated beneficiary accounts. Should the user not presently have a beneficiary accounts at the financial institution, one or more beneficiary accounts may be created at this point. In step 608, the customer chooses which types of transactions (e.g., debit card purchases, checks, online bill pay, and/or credit card purchases) will participate in the round-up savings program. The user-designated beneficiary accounts are accounts at the financial institution into which is deposited the difference between the rounded-up monetary amount and the actual monetary amount involved in the financial payment transaction is transferred from the one or more user-designated financial accounts. The types of user-designated beneficiary accounts to participate in the round-up savings program includes, but is not limited to, any user account associated with a personal account, a commercial account, and a wealth management account. Example accounts may include, but is not limited to, a savings account, a checking account, savings accounts, a money market account (MMA), a certificates of deposit account (CD), lines-of-credit, etc. In accordance with one or more embodiments set forth, described, and/or illustrated herein, a user-designated beneficiary account may comprise a subaccount of any of the user-designated financial accounts.

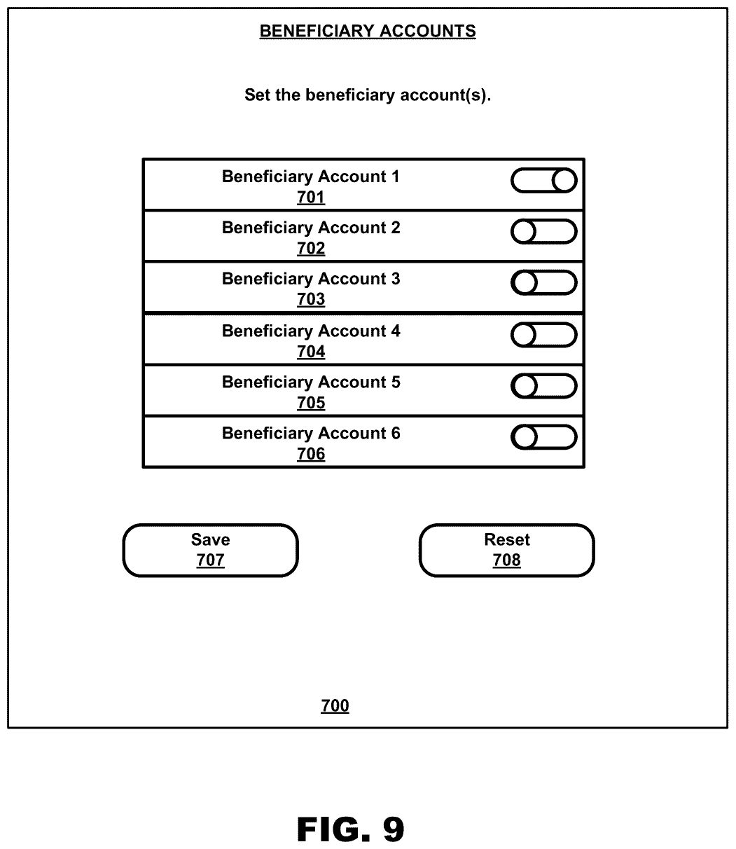

As illustrated in FIG. 9, responsive to the user selectively engaging the tile 504, the computer-executable program code may instruct the one or more processors 210 to cause, over the communication network 300 via the financial institution software application, the display, generation, or rendering of a GUI comprising a beneficiary financial accounts dashboard 700 for visual display on the user interface 130A, 130B of the client device 100. The beneficiary financial accounts dashboard 700 may comprise a widget having a plurality of tiles 701-706 that visually displays the beneficiary financial accounts held by the user at the financial institution. The one or more user-designated beneficiary accounts may comprise subaccounts at the financial institution to which one or more legal minors is designated beneficiary. Each one of the subaccounts may be a savings account associated with a primary financial account held by the parent. The savings account could comprise an account held in trust for the benefit of the one or more minors. Each tile 701-706 includes a user-engageable toggle switch to permit a user to selectively enable or disable one or more user-designated beneficiary financial accounts that will participate in the round-up savings program. The beneficiary financial accounts dashboard 700 also includes a user-engageable icon 707 to save the settings, and a user-engageable icon 708 to reset the settings. The computer-executable program code, in response to the user engaging the user-engageable icon 707 to save the setting, may then instruct the one or more processors 210 to store the selection in the non-transitory memory 220.

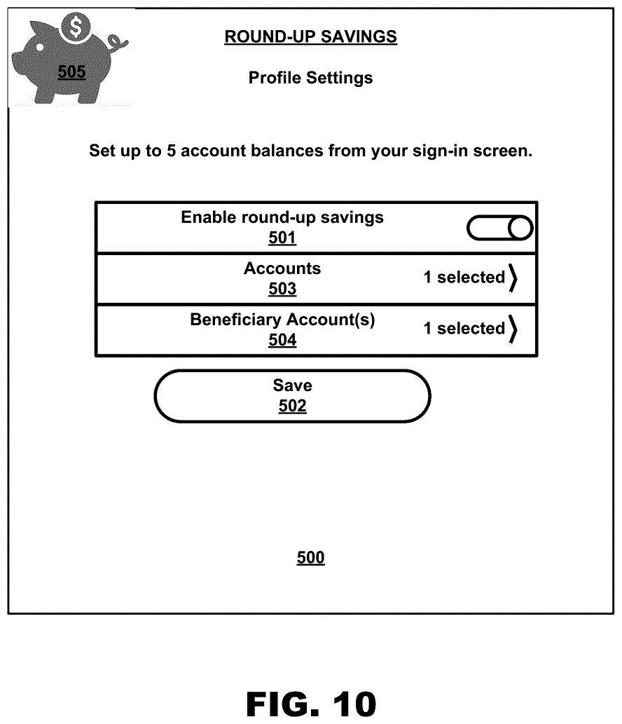

As illustrated in FIG. 10, the computer-executable program code, in response to storing the selection in the non-transitory memory 220, may then instruct the one or more processors 210 to visually display the round-up savings dashboard 500 for visual display on the user interface 130A, 130B to reflect the number of user-designated financial accounts and the user-designated beneficiary financial accounts that have been enabled to participate in the round-up savings program. The round-up savings dashboard 500 may include a visual alert on the round-up savings program dashboard. The visual alert may comprise a user-engageable icon 505 for visual display on the user interface 132 of the client device 100. The user-engageable icon 505 comprises a graphical image prompting the user to selectively preview an account balance in the one or more user-designated beneficiary accounts.

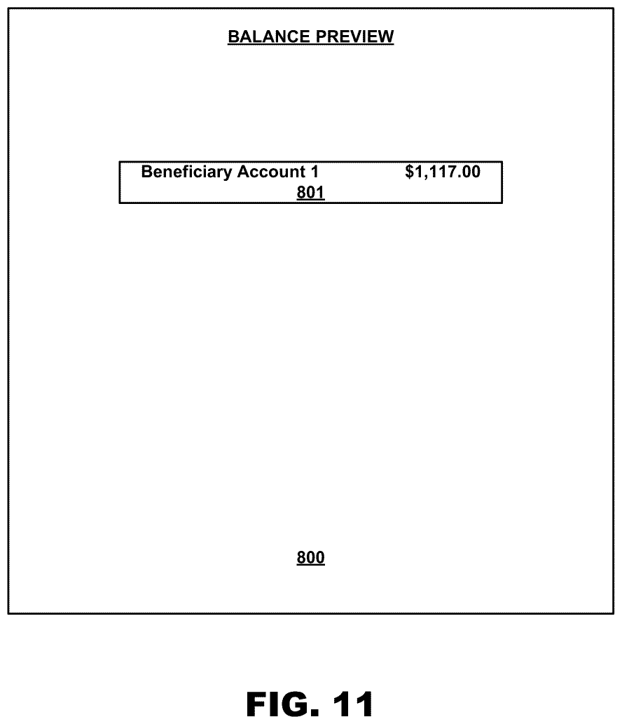

As illustrated in FIG. 11, the computer-executable program code may, responsive to user engagement of the icon 505, instruct the one or more processors 210 to cause, over the communication network 300 via the financial institution software application, the display, generation, or rendering of a GUI comprising a balance preview dashboard 800 for visual display on the user interface 130A, 130B of the client device 100. The balance preview dashboard 800 may comprise a widget having one or more tiles 801 that visually displays a balance preview for each enabled user-designated beneficiary financial account. This disclosure contemplates the computer-executable program code instructing the one or more processors 210 to cause, over the communication network 300 via the financial institution software application, the display, generation, or rendering of a visual notification to the user when a predetermined monetary amount has accumulated in a user-designated beneficiary financial account.

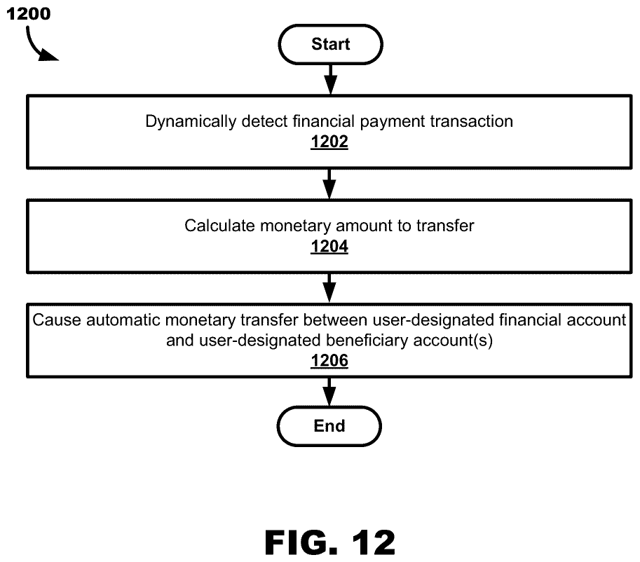

Illustrated examples shown in FIGS. 12 to 15 set forth computer-implemented methods 1200, 1300, 1400, and 1500. In one or more examples, the respective flowcharts of the computer-implemented methods 1200, 1300, 1400, and 1500 may be implemented by the one or more processors 210 of the one or more financial institution servers 200. In particular, the computer-implemented methods 1200, 1300, 1400, and 1500 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, software executed by the one or more financial institution servers 200 provides functionality described or illustrated herein. In particular, software executed by the one or more processors 210 is operable to perform one or more processing blocks of the computer-implemented methods 1200, 1300, 1400, and 1500 set forth, described, and/or illustrated herein, or provides functionality set forth, described, and/or illustrated.

As illustrated in FIG. 12, illustrated process block 1202 includes dynamically detecting, by one or more financial institution servers associated with a financial institution, a financial payment transaction having an actual monetary amount that is paid by a user using funds from a user-designated financial account at the financial institution.

The computer-implemented method 1200 may then proceed to illustrated process block 1204, which includes calculating, by the one or more financial institution servers to a nearest whole number of the monetary amount based on the actual monetary amount, a rounded-up monetary amount.

The computer-implemented method 1200 may then proceed to illustrated process block 1206, which includes causing, by the one or more financial institution servers based on the detection, an automatic monetary transfer representing a difference between the rounded-up monetary amount and the actual monetary amount from the financial account to one or more user-designated beneficiary accounts at the financial institution.

The computer-implemented method 1200 may terminate or end after execution of process block 1206.

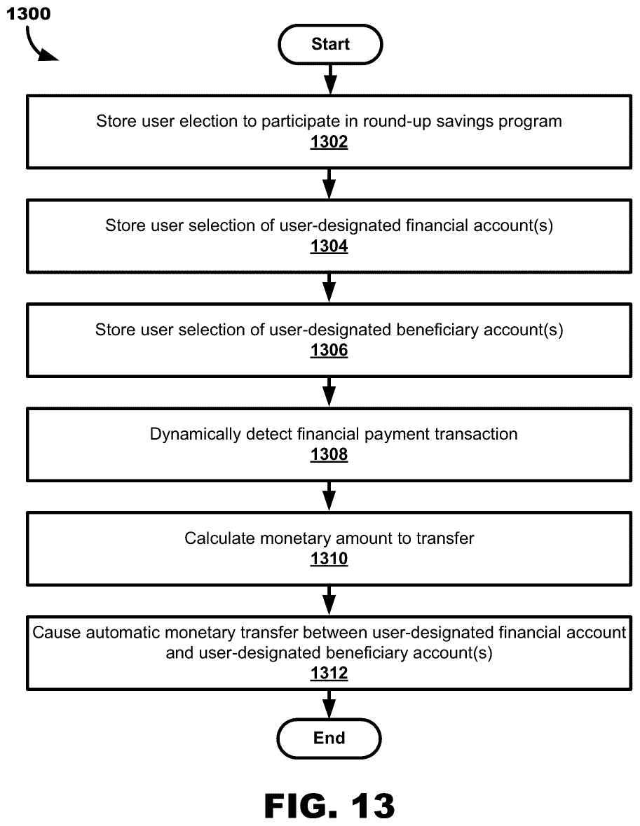

As illustrated in FIG. 13, illustrated process block 1302 includes storing, by one or more financial institution servers associated with a financial institution, an election by a user to participate in a round-up savings program offered by the financial institution.

The computer-implemented method 1300 may then proceed to illustrated process block 1304, which includes storing, by the one or more financial institution servers, a selection by the user of one or more user-designated financial accounts to participate in the round-up savings program.

The computer-implemented method 1300 may then proceed to illustrated process block 1306, which includes storing, by the one or more financial institution servers, a selection by the user of one or more user-designated beneficiary accounts to receive the monetary transfer.

In accordance with illustrated process block 1306, each user-designated beneficiary account comprises a subaccount of the financial account.

The computer-implemented method 1300 may then proceed to illustrated process block 1308, which includes dynamically detecting, by the one or more financial institution servers, a financial payment transaction having an actual monetary amount that is paid by a user using funds from a user-designated financial account at the financial institution.

The computer-implemented method 1300 may then proceed to illustrated process block 1310, which includes calculating, by the one or more financial institution servers to a nearest whole number of the monetary amount based on the actual monetary amount, a rounded-up monetary amount.

The computer-implemented method 1300 may then proceed to illustrated process block 1312, which includes causing, by the one or more financial institution servers based on the detection, an automatic monetary transfer representing a difference between the rounded-up monetary amount and the actual monetary amount from the financial account to one or more user-designated beneficiary accounts at the financial institution.

The computer-implemented method 1300 may terminate or end after execution of process block 1312.

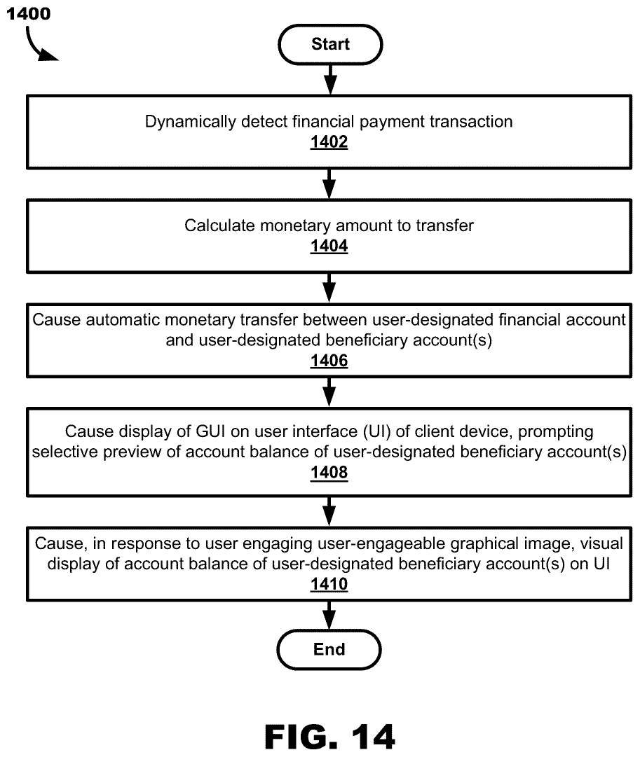

As illustrated in FIG. 14, illustrated process block 1402 includes dynamically detecting, by one or more financial institution servers associated with a financial institution, a financial payment transaction having an actual monetary amount that is paid by a user using funds from a user-designated financial account at the financial institution.

The computer-implemented method 1400 may then proceed to illustrated process block 1404, which includes calculating, by the one or more financial institution servers to a nearest whole number of the monetary amount based on the actual monetary amount, a rounded-up monetary amount.

The computer-implemented method 1400 may then proceed to illustrated process block 1406, which includes causing, by the one or more financial institution servers based on the detection, an automatic monetary transfer representing a difference between the rounded-up monetary amount and the actual monetary amount from the financial account to one or more user-designated beneficiary accounts at the financial institution.

The computer-implemented method 1400 may then proceed to illustrated process block 1408, which includes causing, by the one or more financial institution servers, display of a GUI comprising a visual alert on the user interface (UI) of a client device.

In accordance with illustrated process block 1408, the one or more financial institution servers cause the display of the visual alert after a predetermined lapse of time set by the user.

In accordance with illustrated process block 1408, the visual alert comprises a round-up savings program dashboard that includes the visual alert.

In accordance with illustrated process block 1408, the visual alert comprises a user-engageable graphical image prompting the user to selectively preview an account balance in the one or more user-designated beneficiary accounts.

The computer-implemented method 1400 may then proceed to illustrated process block 1410, which includes causing, by the one or more financial institution servers in response to the user engaging the user-engageable icon, the display of the account balance in the one or more user-designated beneficiary accounts.

The computer-implemented method 1400 may terminate or end after execution of process block 1410.

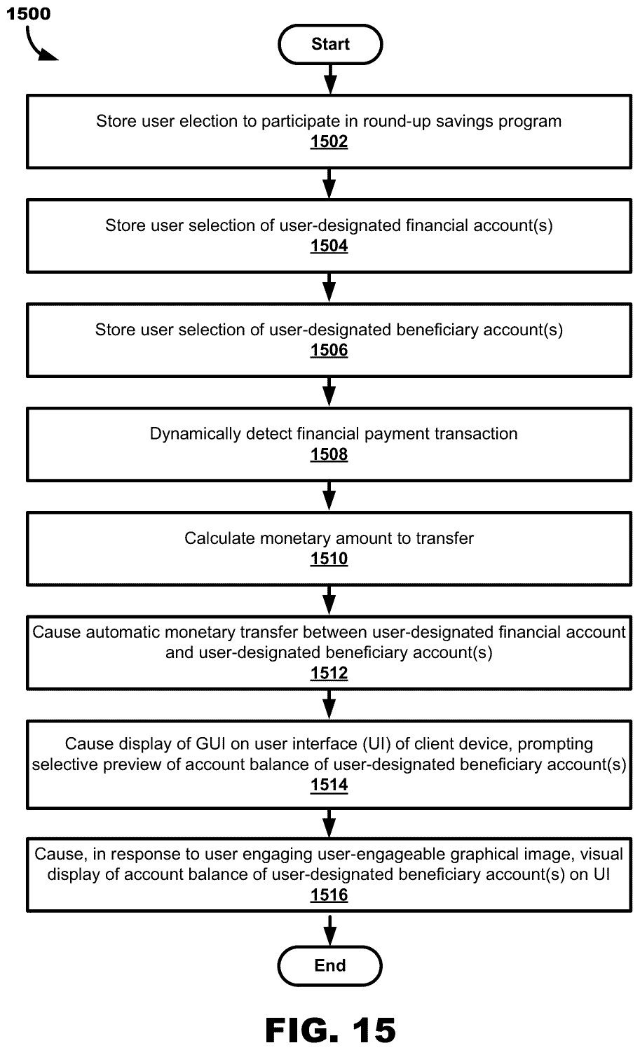

As illustrated in FIG. 15, illustrated process block 1502 includes storing, by one or more financial institution servers associated with a financial institution, an election by a user to participate in a round-up savings program offered by the financial institution.

The computer-implemented method 1500 may then proceed to illustrated process block 1504, which includes storing, by the one or more financial institution servers, a selection by the user of one or more user-designated financial accounts to participate in the round-up savings program.

The computer-implemented method 1500 may then proceed to illustrated process block 1506, which includes storing, by the one or more financial institution servers, a selection by the user of one or more user-designated beneficiary accounts to receive the monetary transfer.

In accordance with illustrated process block 1506, each user-designated beneficiary account comprises a subaccount of the financial account.

The computer-implemented method 1500 may then proceed to illustrated process block 1508, which includes dynamically detecting, by the one or more financial institution servers, a financial payment transaction having an actual monetary amount that is paid by a user using funds from a user-designated financial account at the financial institution.

The computer-implemented method 1500 may then proceed to illustrated process block 1510, which includes calculating, by the one or more financial institution servers to a nearest whole number of the monetary amount based on the actual monetary amount, a rounded-up monetary amount.

The computer-implemented method 1500 may then proceed to illustrated process block 1512, which includes causing, by the one or more financial institution servers based on the detection, an automatic monetary transfer representing a difference between the rounded-up monetary amount and the actual monetary amount from the financial account to one or more user-designated beneficiary accounts at the financial institution.

The computer-implemented method 1500 may then proceed to illustrated process block 1514, which includes causing, by the one or more financial institution servers, display of a GUI comprising a visual alert on the user interface (UI) of a client device.

In accordance with illustrated process block 1514, the one or more financial institution servers cause the display of the visual alert after a predetermined lapse of time set by the user.

In accordance with illustrated process block 1514, the visual display comprises a round-up savings program dashboard that includes the visual alert.

In accordance with illustrated process block 1514, the visual alert comprises a user-engageable graphical image prompting the user to selectively preview an account balance in the one or more user-designated beneficiary accounts.

The computer-implemented method 1500 may then proceed to illustrated process block 1516, which includes causing, by the one or more financial institution servers in response to the user engaging the user-engageable icon, the display of the account balance in the one or more user-designated beneficiary accounts.

The computer-implemented method 1500 may terminate or end after execution of process block 1516.

In accordance with one or more embodiments set forth, described, and/or illustrated herein, the client device 100 and the one or more financial institution server(s) 200 could function in a fully virtualized environment. A virtual machine is where all hardware is virtual and operation is run over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment. For example, a virtual hard disk can store the operating system, data, and application files for a virtual machine. Virtualized computer system includes computing device or physical hardware platform, virtualization software running on hardware platform, and one or more virtual machines running on hardware platform by way of virtualization software. Virtualization software is therefore logically interposed between the physical hardware of hardware platform and guest system software running “in” virtual machine.

Memory of the hardware platform may store virtualization software and guest system software running in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

The system and method described herein may be at least partially processor-implemented, the one or more processors 210 being an example of hardware. For example, at least some of the operations of the computer-implemented methods may be performed by the one or more processors 210 or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors 210, not only residing within a single machine, but deployed across a plurality of machines. In some example embodiments, the one or more processors 210 or processor-implemented modules may be located in a single geographic location (e.g., within a home environment, an office environment, or a server farm). In other example embodiments, the one or more processors or processor-implemented modules may be distributed across a plurality of geographic locations.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in question, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An apparatus, comprising:
one or more processors; and
a non-transitory memory coupled to the one or more processors, the non-transitory memory including a set of instructions of computer-executable program code, which when executed by the one or more processors, cause the apparatus to:
dynamically detect a financial payment transaction having an actual monetary amount that is paid by a user using funds from a user-designated financial account at a financial institution;
calculate, to a nearest whole number of the monetary amount based on the actual monetary amount, a rounded-up monetary amount; and
cause, based on the detection, an automatic monetary transfer representing a difference between the rounded-up monetary amount and the actual monetary amount from the user-designated financial account to one or more user-designated beneficiary accounts at the financial institution.

2. The apparatus of claim 1, wherein the set of instructions, which when executed by the one or more processors, cause the apparatus to:
receive from a client device of the user, an election by the user to participate in a round-up savings program offered by the financial institution, and
store the election in the non-transitory memory.

3. The apparatus of claim 1, wherein the set of instructions, which when executed by the one or more processors, cause the apparatus to:
receive, from the client device, a selection by the user of one or more user-designated financial accounts to participate in the round-up savings program, and
store the selection of the one or more user-designated financial accounts in the non-transitory memory.

4. The apparatus of claim 1, wherein the set of instructions, which when executed by the one or more processors, cause the apparatus to:
receive, from the client device, a selection by the user of the one or more user-designated beneficiary accounts to receive the monetary transfer, each user-designated beneficiary account comprising a subaccount of the financial account, and
store the selection of the one or more user-designated beneficiary accounts in the non-transitory memory.

5. The apparatus of claim 1, wherein the set of instructions, which when executed by the one or more processors, cause the apparatus to cause display of, on a user interface of the client device, a graphical user interface (GUI) comprising a round-up savings program dashboard via a software application associated with the financial institution, the round-up savings program dashboard including a visual alert.

6. The apparatus of claim 5, wherein the visual alert comprises a user-engageable graphical image prompting the user to selectively preview an account balance in the one or more user-designated beneficiary accounts.

7. The apparatus of claim 6, wherein the set of instructions, which when executed by the one or more processors, cause the apparatus to cause, in response to the user engaging the user-engageable icon, the display of the account balance in the one or more user-designated beneficiary accounts.

8. A computer program product comprising at least one non-transitory computer readable medium having with a set of instructions of computer-executable program code, which when executed by one or more processors of a computing device, cause the computing device to:
dynamically detect a financial payment transaction having an actual monetary amount that is paid by a user using funds from a user-designated financial account at a financial institution;
calculate, to a nearest whole number of the monetary amount based on the actual monetary amount, a rounded-up monetary amount; and
cause, based on the detection, an automatic monetary transfer representing a difference between the rounded-up monetary amount and the actual monetary amount from the financial account to one or more user-designated beneficiary accounts at the financial institution.

9. The computer program product of claim 8, wherein the set of instructions, which when executed by the one or more processors, cause the computing device to:
receive from a client device of the user, an election by the user to participate in a round-up savings program offered by the financial institution, and
store the election in the non-transitory memory.

10. The computer program product of claim 8, wherein the set of instructions, which when executed by the one or more processors, cause the computing device to:
receive, from the client device, a selection by the user of one or more user-designated financial accounts to participate in the round-up savings program, and
store the selection of the one or more user-designated financial accounts in the non-transitory memory.

11. The computer program product of claim 8, wherein the set of instructions, which when executed by the one or more processors, cause the computing device to:
receive, from the client device, a selection by the user of the one or more user-designated beneficiary accounts to receive the monetary transfer, each user-designated beneficiary account comprising a subaccount of the financial account, and
store the selection of the one or more user-designated beneficiary accounts in the non-transitory memory.

12. The computer program product of claim 8, wherein the set of instructions, which when executed by the one or more processors, cause the computing device to cause display of, on a user interface of the client device, a round-up savings program dashboard via a software application associated with the financial institution, including a graphical user interface (GUI) comprising a visual alert on the round-up savings program dashboard.

13. The computer program product of claim 12, wherein the visual alert comprises a user-engageable graphical image prompting the user to selectively preview an account balance in the one or more user-designated beneficiary accounts.

14. The apparatus of claim 13, wherein the set of instructions, which when executed by the one or more processors, cause the computing device to cause, in response to the user engaging the user-engageable graphical image, the display of the account balance in the one or more user-designated beneficiary accounts.

15. A computer-implemented method, comprising:
dynamically detecting, by one or more financial institution servers associated with a financial institution, a financial payment transaction having an actual monetary amount that is paid by a user using funds from a user-designated financial account at the financial institution;
calculating, by the one or more financial institution servers to a nearest whole number of the monetary amount based on the actual monetary amount, a rounded-up monetary amount; and
causing, by the one or more financial institution servers based on the detection, an automatic monetary transfer representing a difference between the rounded-up monetary amount and the actual monetary amount from the financial account to one or more user-designated beneficiary accounts at the financial institution.

16. The computer-implemented method of claim 15, further comprising:
receiving, by the one or more financial institution servers from a client device of the user, an election by the user to participate in a round-up savings program offered by the financial institution, and
storing, by the one or more financial institution servers, the election in non-transitory memory of the one or more financial institution servers.

17. The computer-implemented method of claim 16, further comprising:
receiving, by the one or more financial institution servers from the client device, a selection by the user of one or more user-designated financial accounts to participate in the round-up savings program, and
storing, by the one or more financial institution servers, the selection of the one or more user-designated financial accounts in the non-transitory memory.

18. The computer-implemented method of claim 17, further comprising:
receiving, by the one or more financial institution servers from the client device, a selection by the user of the one or more user-designated beneficiary accounts to receive the monetary transfer, each user-designated beneficiary account comprising a subaccount of the financial account, and
storing, by the one or more financial institution servers, the selection of the one or more user-designated beneficiary accounts in the non-transitory memory.

19. The computer-implemented method of claim 18, further comprising:
causing display of, via a software application associated with the financial institution, a first GUI comprising a round-up savings program dashboard on a user interface of the client device, the round-up savings program dashboard including a second GUI comprising a visual alert on the round-up savings program dashboard.

20. The computer-implemented method of claim 19, wherein the visual alert comprises a user-engageable graphical image prompting the user to selectively preview an account balance in the one or more user-designated beneficiary accounts.
